(19) United States
(12) Patent Application Publication
(10) Pub. No.: US 2024/0056253 A1
(43) Pub. Date: Feb. 15, 2024

(54) TECHNIQUES FOR PSEUDO-RANDOM MUTING FOR SOUNDING REFERENCE SIGNAL

(71) Applicant: QUALCOMM Incorporated, San Diego, CA (US)

(72) Inventors: Mostafa KHOSHNEVISAN, San Diego, CA (US); Yitao CHEN, San Diego, CA (US); Peter GAAL, San Diego, CA (US)

(21) Appl. No.: 17/819,497

(22) Filed: Aug. 12, 2022

(51) Int. Cl. H04L 5/00; H04W 76/20

(52) U.S. Cl. CPC H04L 5/0051; H04W 76/20

(57) ABSTRACT

Various aspects of the present disclosure generally relate to wireless communication. In some aspects, a user equipment (UE) may receive information indicating an offset for a pseudo-random function used to select a set of sounding reference signal (SRS) transmission occasions from a plurality of SRS transmission occasions. The UE may transmit one or more SRSs on the set of SRS transmission occasions based at least in part on the offset and the pseudo-random function. Numerous other aspects are described.

### FIELD OF THE DISCLOSURE

Aspects of the present disclosure generally relate to wireless communication and to techniques and apparatuses for pseudo-random muting for a sounding reference signal (SRS).

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving information indicating an offset for a pseudo-random function used to select a set of sounding reference signal (SRS) transmission occasions from a plurality of SRS transmission occasions. The method may include transmitting one or more SRSs on the set of SRS transmission occasions based at least in part on the offset and the pseudo-random function.

Some aspects described herein relate to a method of wireless communication performed by a UE. The method may include receiving an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission. The method may include transmitting one or more SRSs on the one or more SRS transmission occasions based at least in part on the initialization value and a time associated with an SRS transmission occasion of the two or more pluralities of SRS transmission occasions.

Some aspects described herein relate to a method of wireless communication performed by a network node. The method may include outputting information indicating an offset for a pseudo-random function used to select a set of SRS transmission occasions from a plurality of SRS transmission occasions. The method may include obtaining one or more SRSs on the set of SRS transmission occasions based at least in part on the offset and the pseudo-random function.

Some aspects described herein relate to a method of wireless communication performed by a network node. The method may include outputting an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission. The method may include obtaining one or more SRSs on the one or more SRS transmission occasions based at least in part on the initialization value and a time associated with an SRS transmission occasion of the two or more pluralities of SRS transmission occasions.

Some aspects described herein relate to a UE for wireless communication. The UE may include a memory and one or more processors coupled to the memory. The one or more processors may be configured to receive information indicating an offset for a pseudo-random function used to select a set of SRS transmission occasions from a plurality of SRS transmission occasions. The one or more processors may be configured to transmit one or more SRSs on the set of SRS transmission occasions based at least in part on the offset and the pseudo-random function.

Some aspects described herein relate to a UE for wireless communication. The UE may include a memory and one or more processors coupled to the memory. The one or more processors may be configured to receive an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission. The one or more processors may be configured to transmit one or more SRSs on the one or more SRS transmission occasions based at least in part on the initialization value and a time associated with an SRS transmission occasion of the two or more pluralities of SRS transmission occasions.

Some aspects described herein relate to a network node for wireless communication. The network node may include a memory and one or more processors coupled to the memory. The one or more processors may be configured to output information indicating an offset for a pseudo-random function used to select a set of SRS transmission occasions from a plurality of SRS transmission occasions. The one or more processors may be configured to obtain one or more SRSs on the set of SRS transmission occasions based at least in part on the offset and the pseudo-random function.

Some aspects described herein relate to a network node for wireless communication. The network node may include a memory and one or more processors coupled to the memory. The one or more processors may be configured to output an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission. The one or more processors may be configured to obtain one or more SRSs on the one or more SRS transmission occasions based at least in part on the initialization value and a time associated with an SRS transmission occasion of the two or more pluralities of SRS transmission occasions.

Some aspects described herein relate to a non-transitory computer-readable medium that stores a set of instructions for wireless communication by a UE. The set of instructions, when executed by one or more processors of the UE, may cause the UE to receive information indicating an offset for a pseudo-random function used to select a set of SRS transmission occasions from a plurality of SRS transmission occasions. The set of instructions, when executed by one or more processors of the UE, may cause the UE to transmit one or more SRSs on the set of SRS transmission occasions based at least in part on the offset and the pseudo-random function.

Some aspects described herein relate to a non-transitory computer-readable medium that stores a set of instructions for wireless communication by a UE. The set of instructions, when executed by one or more processors of the UE, may cause the UE to receive an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission. The set of instructions, when executed by one or more processors of the UE, may cause the UE to transmit one or more SRSs on the one or more SRS transmission occasions based at least in part on the initialization value and a time associated with an SRS transmission occasion of the two or more pluralities of SRS transmission occasions.

Some aspects described herein relate to a non-transitory computer-readable medium that stores a set of instructions for wireless communication by a network node. The set of instructions, when executed by one or more processors of the network node, may cause the network node to output information indicating an offset for a pseudo-random function used to select a set of SRS transmission occasions from a plurality of SRS transmission occasions. The set of instructions, when executed by one or more processors of the network node, may cause the network node to obtain one or more SRSs on the set of SRS transmission occasions based at least in part on the offset and the pseudo-random function.

Some aspects described herein relate to a non-transitory computer-readable medium that stores a set of instructions for wireless communication by a network node. The set of instructions, when executed by one or more processors of the network node, may cause the network node to output an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission. The set of instructions, when executed by one or more processors of the network node, may cause the network node to obtain one or more SRSs on the one or more SRS transmission occasions based at least in part on the initialization value and a time associated with an SRS transmission occasion of the two or more pluralities of SRS transmission occasions.

Some aspects described herein relate to an apparatus for wireless communication. The apparatus may include means for receiving information indicating an offset for a pseudo-random function used to select a set of SRS transmission occasions from a plurality of SRS transmission occasions. The apparatus may include means for transmitting one or more SRSs on the set of SRS transmission occasions based at least in part on the offset and the pseudo-random function.

Some aspects described herein relate to an apparatus for wireless communication. The apparatus may include means for receiving an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission. The apparatus may include means for transmitting one or more SRSs on the one or more SRS transmission occasions based at least in part on the initialization value and a time associated with an SRS transmission occasion of the two or more pluralities of SRS transmission occasions.

Some aspects described herein relate to an apparatus for wireless communication. The apparatus may include means for outputting information indicating an offset for a pseudo-random function used to select a set of SRS transmission occasions from a plurality of SRS transmission occasions. The apparatus may include means for obtaining one or more SRSs on the set of SRS transmission occasions based at least in part on the offset and the pseudo-random function.

Some aspects described herein relate to an apparatus for wireless communication. The apparatus may include means for outputting an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission. The apparatus may include means for obtaining one or more SRSs on the one or more SRS transmission occasions based at least in part on the initialization value and a time associated with an SRS transmission occasion of the two or more pluralities of SRS transmission occasions.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 illustrates an example logical architecture of a distributed radio access network (RAN), in accordance with the present disclosure.

FIG. 5 is a diagram illustrating an example of sounding reference signal (SRS) resource sets, in accordance with the present disclosure.

FIG. 6 is a diagram illustrating an example of multiple transmission reception point communication, in accordance with the present disclosure.

FIG. 7 is a diagram illustrating an example of pseudo-random muting of SRS transmissions, in accordance with the present disclosure.

FIG. 8 is a diagram illustrating an example of signaling associated with selecting SRS transmission occasions using an offset, in accordance with the present disclosure.

FIG. 9 is a diagram illustrating an example of two or more binary sequences for SRS transmission occasions, in accordance with the present disclosure.

FIG. 10 is a diagram illustrating an example process performed, for example, by a UE, in accordance with the present disclosure.

FIG. 11 is a diagram illustrating an example process performed, for example, by a UE, in accordance with the present disclosure.

FIG. 12 is a diagram illustrating an example process performed, for example, by a network node, in accordance with the present disclosure.

FIG. 13 is a diagram illustrating an example process performed, for example, by a network node, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

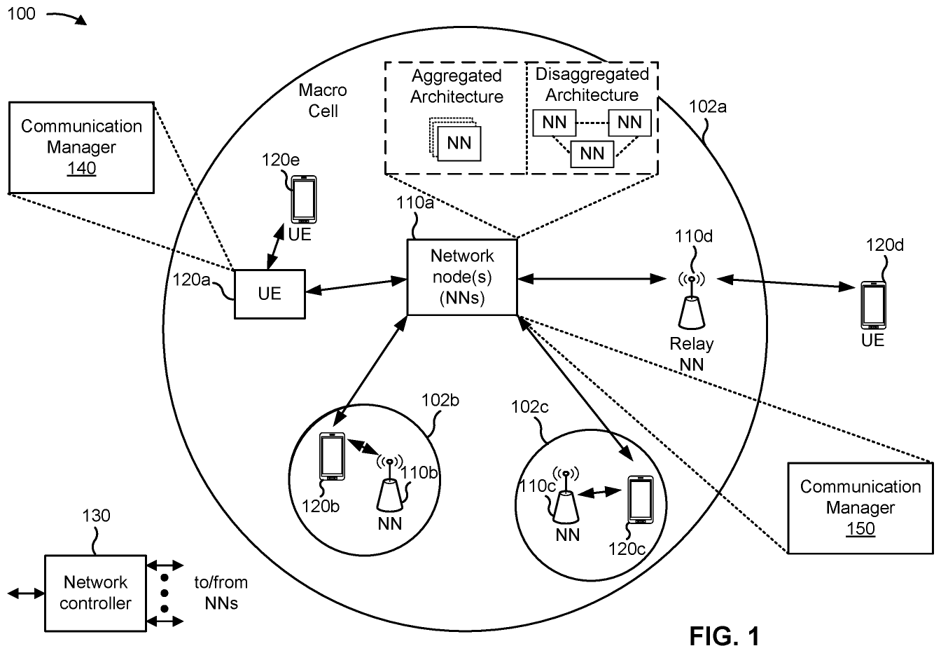

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a UE 120 may include a communication manager 140. As described in more detail elsewhere herein, the communication manager 140 may receive information indicating an offset for a pseudo-random function used to select a set of sounding reference signal (SRS) transmission occasions from a plurality of SRS transmission occasions; and transmit one or more SRSs on the set of SRS transmission occasions based at least in part on the offset and the pseudo-random function. In some aspects, the communication manager 140 may receive an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission; and transmit one or more SRSs on the one or more SRS transmission occasions based at least in part on the initialization value and a time associated with an SRS transmission occasion of the two or more pluralities of SRS transmission occasions. Additionally, or alternatively, the communication manager 140 may perform one or more other operations described herein.

In some aspects, a network node 110 may include a communication manager 150. As described in more detail elsewhere herein, the communication manager 150 may output information indicating an offset for a pseudo-random function used to select a set of SRS transmission occasions from a plurality of SRS transmission occasions; and obtain one or more SRSs on the set of SRS transmission occasions based at least in part on the offset and the pseudo-random function. In some aspects, the communication manager 150 may output an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission; and obtain one or more SRSs on the one or more SRS transmission occasions based at least in part on the initialization value and a time associated with an SRS transmission occasion of the two or more pluralities of SRS transmission occasions. Additionally, or alternatively, the communication manager 150 may perform one or more other operations described herein.

As indicated above, FIG. 1 is provided as an example. Other examples may differ from what is described with regard to FIG. 1.

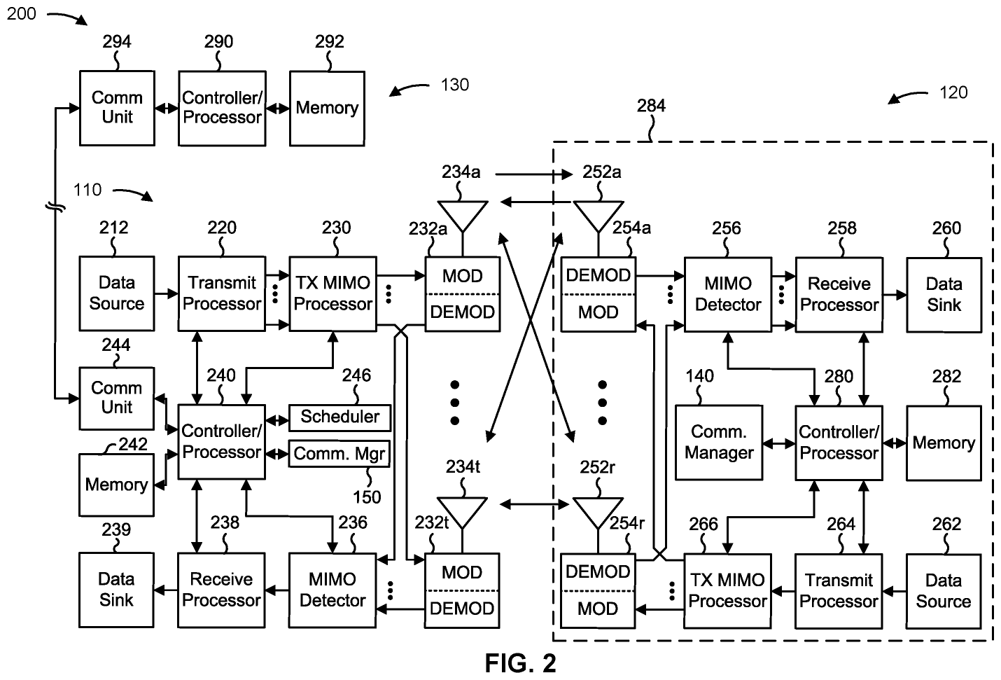

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

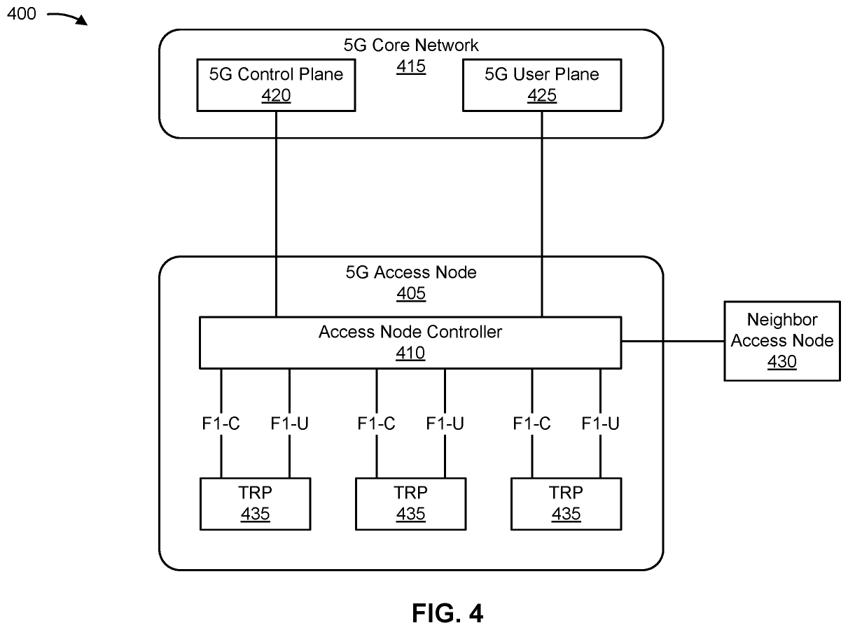

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-15).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-15).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

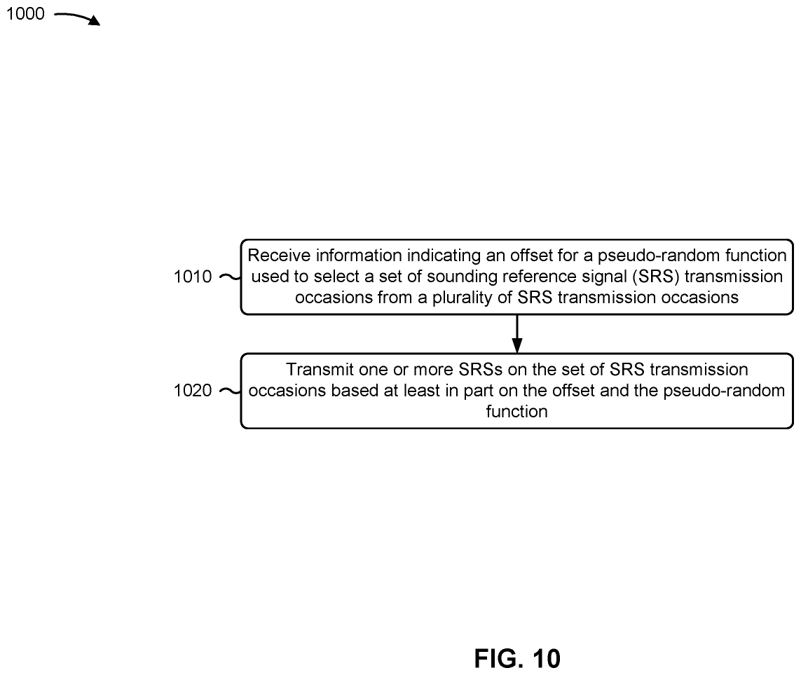

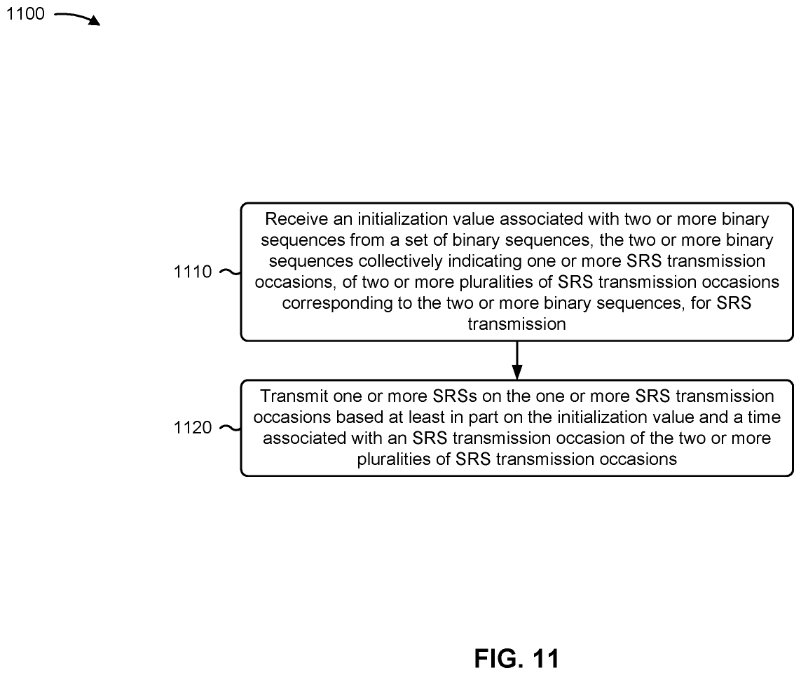

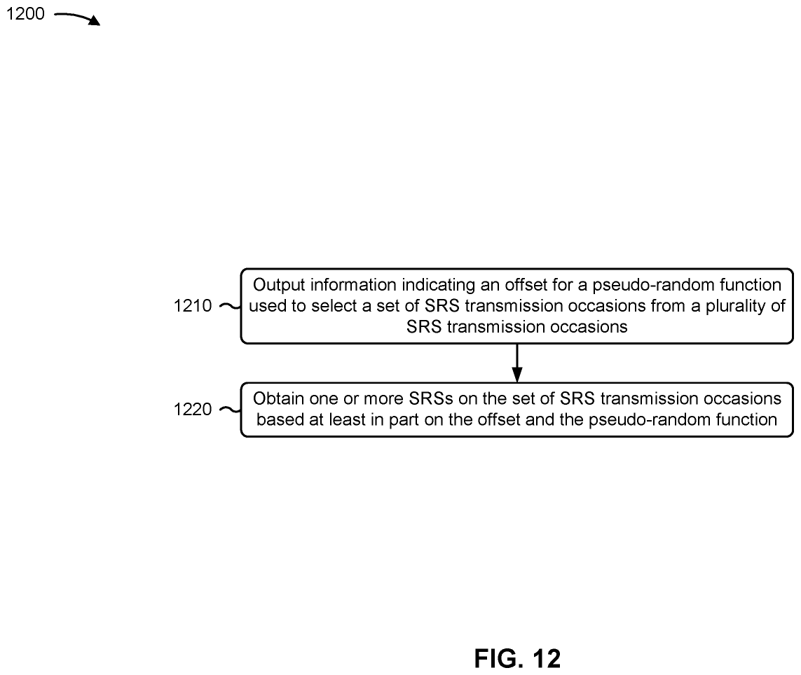

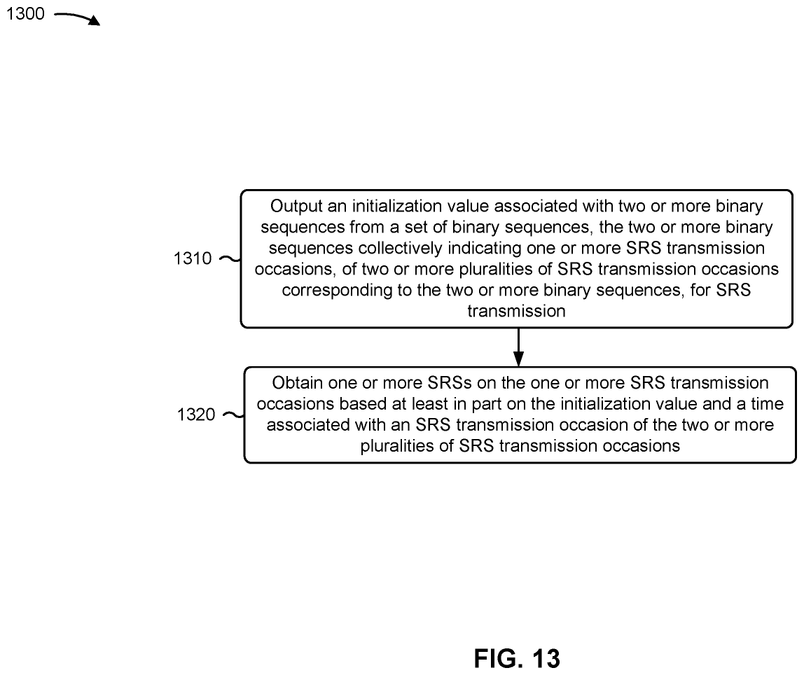

The controller/processor 240 of the network node 110, the controller/processor 280 of the UE 120, or any other component(s) of FIG. 2 may perform one or more techniques associated with pseudo-random muting for an SRS, as described in more detail elsewhere herein. For example, the controller/processor 240 of the network node 110, the controller/processor 280 of the UE 120, or any other component(s) (or combinations of components) of FIG. 2 may perform or direct operations of, for example, process 1000 of FIG. 10, process 1100 of FIG. 11, process 1200 of FIG. 12, process 1300 of FIG. 13, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1000 of FIG. 10, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for receiving information indicating an offset for a pseudo-random function used to select a set of SRS transmission occasions from a plurality of SRS transmission occasions; and/or means for transmitting one or more SRSs on the set of SRS transmission occasions based at least in part on the offset and the pseudo-random function. In some aspects, the UE 120 includes means for receiving an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission; and/or means for transmitting one or more SRSs on the one or more SRS transmission occasions based at least in part on the initialization value and a time associated with an SRS transmission occasion of the two or more pluralities of SRS transmission occasions. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for outputting information indicating an offset for a pseudo-random function used to select a set of SRS transmission occasions from a plurality of SRS transmission occasions; and/or means for obtaining one or more SRSs on the set of SRS transmission occasions based at least in part on the offset and the pseudo-random function. In some aspects, the network node 110 includes means for outputting an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission; and/or means for obtaining one or more SRSs on the one or more SRS transmission occasions based at least in part on the initialization value and a time associated with an SRS transmission occasion of the two or more pluralities of SRS transmission occasions. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

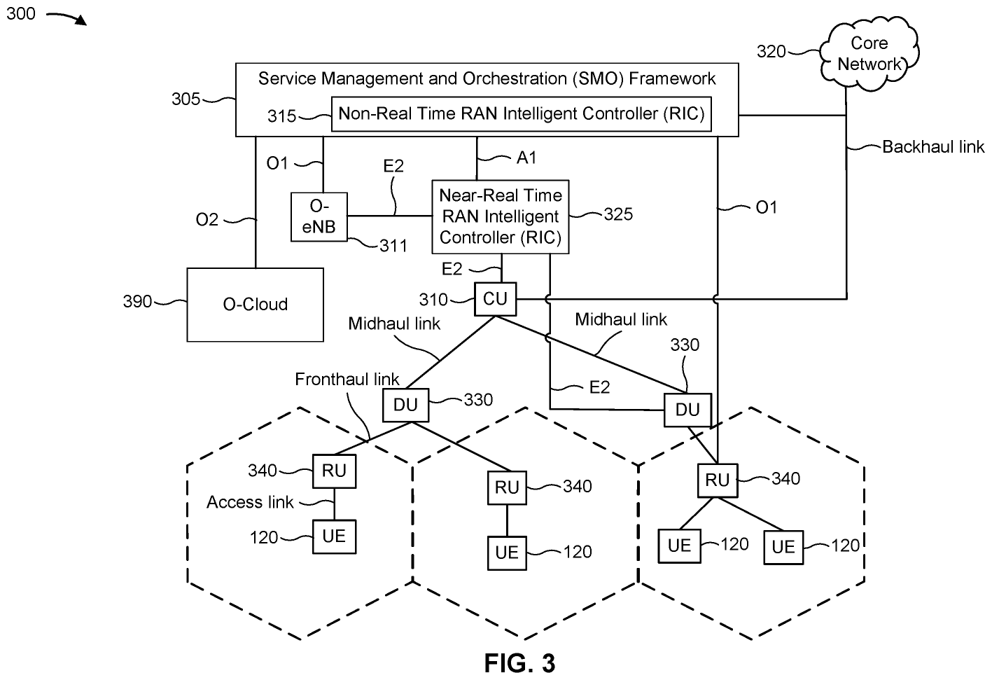

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a DU of the distributed RAN 400. In some aspects, a TRP 435 may correspond to a network node 110 described above in connection with FIG. 1. For example, different TRPs 435 may be included in different network nodes 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a PDCP layer, an RLC layer, and/or a medium access control (MAC) layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using coherent joint transmission (CJT) with one or more other TRPs 435) serve traffic to a UE 120. As described in more detail below, multi-TRP communication (e.g., communications by multiple TRPs or between the multiple TRPs) with a plurality of UEs may result in interference and/or network congestion.

As indicated above, FIG. 4 is provided as an example. Other examples may differ from what is described with regard to FIG. 4.

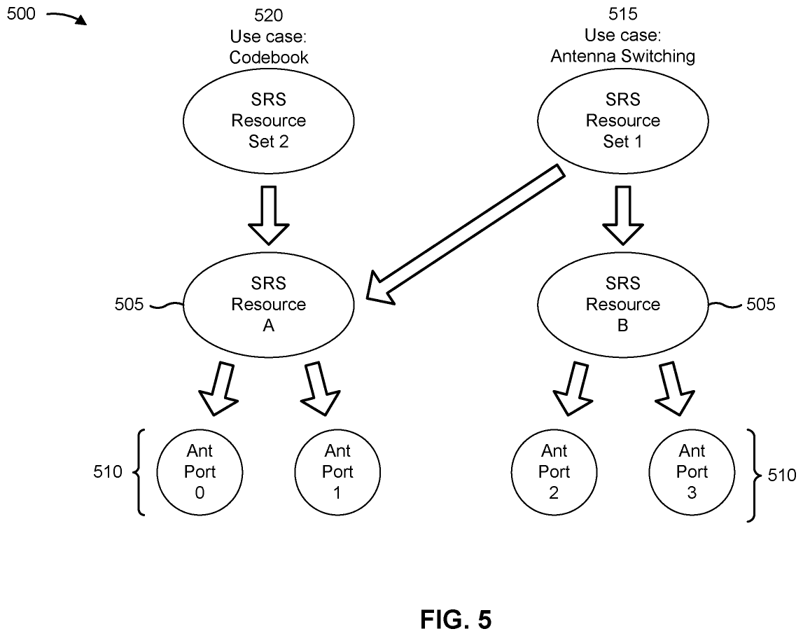

FIG. 5 is a diagram illustrating an example 500 of SRS resource sets, in accordance with the present disclosure.

A UE 120 may be configured with one or more SRS resource sets to allocate resources for SRS transmissions by the UE 120. For example, a configuration for SRS resource sets may be indicated in a radio resource control (RRC) message (e.g., an RRC configuration message or an RRC reconfiguration message). As shown by reference number 505, an SRS resource set may include one or more resources (e.g., shown as SRS resources), which may include time resources and/or frequency resources (e.g., a slot, a symbol, a resource block, and/or a periodicity for the time resources).

As shown by reference number 510, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some aspects, the configuration for an SRS resource set may indicate a use case (e.g., in an SRS-SetUse information element) for the SRS resource set. For example, an SRS resource set may have a use case of antenna switching, codebook, non-codebook, or beam management.

An antenna switching SRS resource set may be used to indicate downlink CSI with reciprocity between an uplink and downlink channel. For example, when there is reciprocity between an uplink channel and a downlink channel, a network node 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a network node 110 indicates an uplink precoder to the UE 120. For example, when the network node 110 is configured to indicate an uplink precoder to the UE 120 (e.g., using a precoder codebook), the network node 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the network node 110). In some aspects, virtual ports (e.g., a combination of two or more antenna ports) with a maximum transmit power may be supported at least for a codebook SRS.

A non-codebook SRS resource set may be used to indicate uplink CSI when the UE 120 selects an uplink precoder (e.g., instead of the network node 110 indicating an uplink precoder to be used by the UE 120). For example, when the UE 120 is configured to select an uplink precoder, the network node 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the network node 110).

A beam management SRS resource set may be used for indicating CSI for millimeter wave communications.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a medium access control (MAC) control element (CE) (MAC-CE)). An aperiodic SRS resource may be triggered dynamically, such as via DCI (e.g., UE-specific DCI or group common DCI) or a MAC-CE.

In some aspects, the UE 120 may be configured with a mapping between SRS ports (e.g., antenna ports) and corresponding SRS resources. The UE 120 may transmit an SRS on a particular SRS resource using an SRS port indicated in the configuration. In some aspects, an SRS resource may span N adjacent symbols within a slot (e.g., where N equals 1, 2, or 4). The UE 120 may be configured with X SRS ports (e.g., where X≤4). In some aspects, each of the X SRS ports may be mapped to a corresponding symbol of the SRS resource and used for transmission of an SRS in that symbol.

As shown in FIG. 5, in some aspects, different SRS resource sets indicated to the UE 120 (e.g., having different use cases) may overlap (e.g., in time and/or in frequency, such as in the same slot). For example, as shown by reference number 515, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRSs may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 520, a second SRS resource set (e.g., shown as SRS Resource Set 2) may be a codebook use case. As shown, this example codebook SRS resource set includes only the first SRS resource (shown as SRS Resource A). Thus, codebook SRSs may be transmitted in SRS Resource A (e.g., the first time-frequency resource) using antenna port 0 and antenna port 1. In this case, the UE 120 may not transmit codebook SRSs in SRS Resource B (e.g., the second time-frequency resource) using antenna port 2 and antenna port 3.

As indicated above, FIG. 5 is provided as an example. Other examples may differ from what is described with regard to FIG. 5.

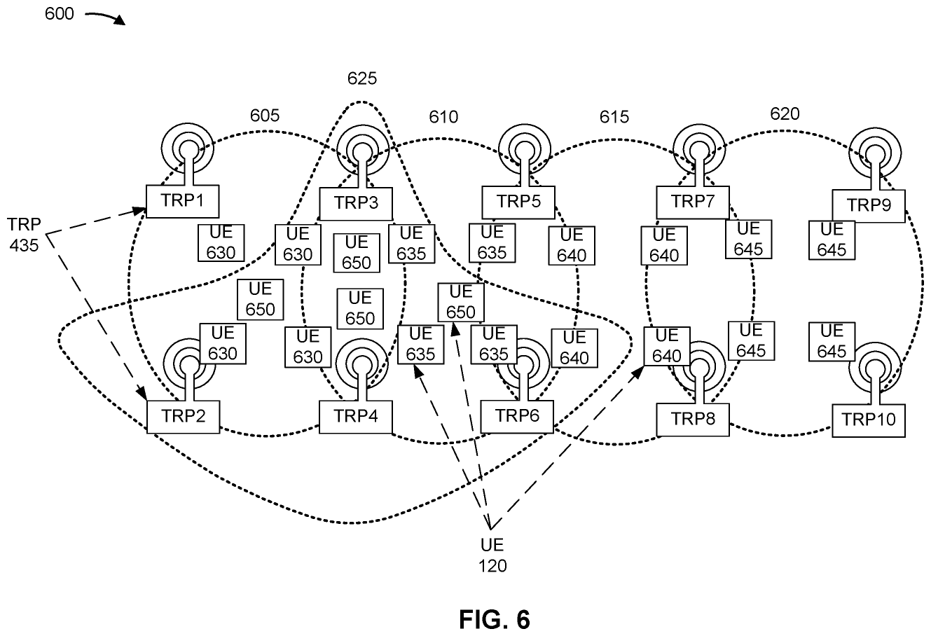

FIG. 6 is a diagram illustrating an example 600 of multi-TRP communication, in accordance with the present disclosure. Multiple TRPs may communicate with a plurality of UEs. For example, ten TRPs (labeled TRP1 through TRP10) may communicate with multiple UEs. The TRPs may be similar or identical to the TRP 435, and the UEs may be similar or identical to the UE 120. Each TRP may be associated with one or more clusters, such as the clusters 605, 610, 615, 620, and 625. The UEs may be located at different points in a cluster (e.g., a coverage area of a cluster), may move within the cluster, and/or may move between clusters. As described herein, the TRPs may communicate using CJT to serve traffic to the UEs. For example, TRPs 1, 2, 3, and 4 may communicate using CJT to serve traffic to the UEs associated with a cluster 605 corresponding to TRPs 1, 2, 3, and 4 (these UEs are labeled as UE 630). TRPs 3, 4, 5, and 6 may communicate using CJT to serve traffic to the UEs associated with a cluster 610 corresponding to TRPs 3, 4, 5, and 6 (these UEs are labeled as UE 635). TRPs 5, 6, 7, and 8 may communicate using CJT to serve traffic to the UEs associated with a cluster 615 corresponding to TRPs 5, 6, 7, and 8 (these UEs are labeled as UE 640). TRPs 7, 8, 9, and 10 may communicate using CJT to serve traffic to the UEs associated with a cluster 620 corresponding to TRPs 7, 8, 9, and 10 (these UEs are labeled as UE 645). As another example, TRPs 2, 3, 4, and 6 may communicate using CJT to serve traffic to UEs associated with a cluster 625 corresponding to TRPs 2, 3, 4, and 6 (these UEs are labeled as UE 650). A cluster is a group of TRPs that jointly process signaling (e.g., downlink transmissions or uplink receptions) for users (e.g., UEs 120) communicating with the group of TRPs. For example, a cluster may include a group of TRPs that communicate using CJT with one or more UEs. The TRPs belonging to a cluster may communicate with one another (e.g., regarding channel state information, received signaling, joint encoding, or the like) to facilitate communication using CJT.

TRPs, such as TRPs communicating using CJT, may obtain channel state information (CSI) to support CJT. For example, a TRP may obtain CSI using an SRS transmission of one or more UEs. In some examples, TRPs associated with a cluster may obtain CSI regarding links between the TRPs and UEs associated with the cluster, such as by triggering SRS transmissions by each of the UEs.

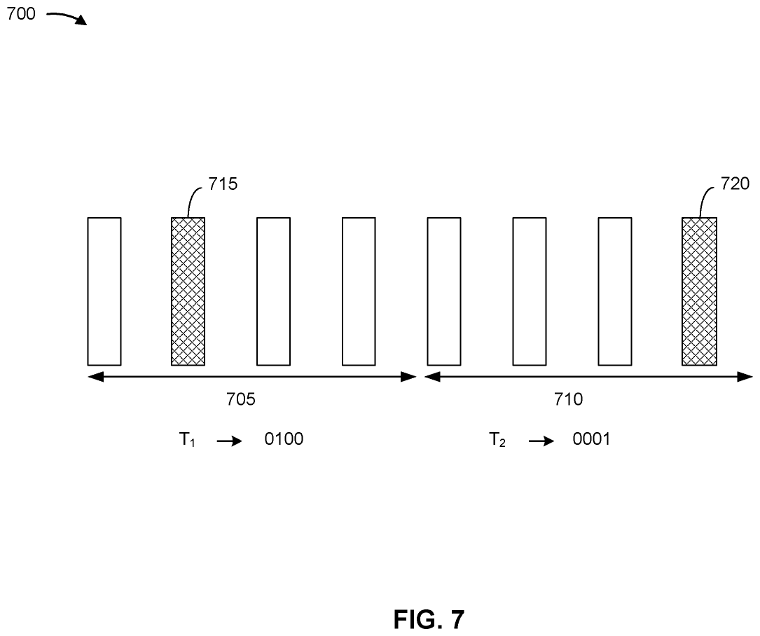

In some cases, multiple TRPs may receive SRS transmissions from a UE. For example, a UE receiving communications using CJT from multiple TRPs may transmit an SRS, which may be used by each of the multiple TRPs to determine CSI. As the number of UEs transmitting the SRS to a given TRP (e.g., the number of UEs belonging to a cluster associated with the given TRP) increases, the UEs may need to send the SRSs on the same OFDM symbols (from the perspective of the given TRP). For example, a single OFDM symbol (or more than one OFDM symbol) may include SRSs from multiple UEs. Overlapping SRS transmission on the same OFDM symbol(s) may degrade the quality of CSI determined using the SRSs due to interference between the SRSs. Thus, interference randomization may be used to reduce inter-cluster interference. In some examples, the interference randomization may include group hopping or sequence hopping (in the SRS base sequence domain). Additionally, or alternatively, the interference randomization may include cyclic shift hopping or comb sequence hopping. However, as the UEs transmit SRS with higher power (e.g., to enable the multiple TRPs to estimate the channel for CJT), these interference randomization and mitigation techniques may not be sufficient to reduce the interference in the network, for example, due to a given SRS having a larger coverage area when transmitted at a higher power. One technique for mitigating interference associated with SRS transmission is pseudo-random muting (equivalently, pseudo-random transmission), in which SRS transmission occasions of a UE are pseudo-randomly muted or selected for transmission of an SRS, thereby increasing sparseness of SRS transmission while still supporting CSI determination using the SRS. Pseudo-random muting is described in more detail in connection with FIG. 7.

As indicated above, FIG. 6 is provided as an example. Other examples may differ from what is described with regard to FIG. 6.

FIG. 7 is a diagram illustrating an example 700 of pseudo-random muting of SRS transmissions, in accordance with the present disclosure. Example 700 shows SRS transmission occasions, also referred to as candidate occasions. An SRS transmission occasion is an SRS resource (or an SRS resource set, in some aspects) that may, or may not, be selected for SRS transmission by a UE (e.g., UE 120).

SRS transmission occasions may be grouped into a plurality of SRS transmission occasions, also referred to as a “bundle.” In example 700, there are two bundles 705 and 710 (i.e., two pluralities of SRS occasions), each including 4 SRS transmission occasions. The number of SRS transmission occasions belonging to a bundle may be denoted L. L may be configurable, for example, by a network node (e.g., network node 110).

In some cases, SRS muting may be performed in a pseudo-random manner to reduce interference. For example, an SRS resource may be configured with a pseudo-random sequence for muting an SRS associated with the SRS resource, and the UE 120 may transmit the SRS, or mute the SRS, based at least in part on the pseudo-random sequence. The pseudo-random sequence may be used to determine whether, at a given time, the UE 120 should transmit the SRS (e.g., the SRS should not be muted) or should not transmit the SRS (e.g., the SRS should be muted). In some cases, the UE 120 may determine whether or not to transmit the SRS based at least in part on performing an operation between a pseudo-random number associated with the pseudo-random sequence and an integer, and/or by comparing a result of the operation between the pseudo-random number and the integer to a threshold. The pseudo-random sequence may be a function of time and, in some cases, may be a function of one or more additional parameters to increase randomness, such as one or more of a comb offset index, a cyclic shift index, or an SRS sequence index (e.g., a group index or sequence index within the group) associated with the SRS resource.

A subset of SRS transmission occasions of a bundle may be selected for SRS transmission. For example, the subset of SRS transmission occasions may be selected in a pseudo-random fashion, which is referred to herein as pseudo-random muting (that is, pseudo-random muting of the SRS transmission occasions not selected for SRS transmission). A benefit of pseudo-random muting (or pseudo-random transmission) of SRS transmission occasions is that the interference level in the system is reduced as some SRS occasions for some UEs are muted. Another benefit is that, for a given SRS transmission occasion of a given UE, in different instances of transmission (that is, in different slots or symbols), different sets of UEs create interference. This avoids consistent interference from a given UE. Since the pseudo-random sequence and corresponding parameters are known, the intended receivers (e.g., TRPs) can determine when SRS transmission from a given UE is expected to occur.

In some aspects, pseudo-random muting may be implemented using a binary sequence based approach. For example, for a bundle of L SRS transmission occasions, the UE may select a binary sequence of length L from a set of binary sequences. Each of the set of binary sequences may be of length L. The UE may select the binary sequence in a pseudo-random manner, as described above. A first value (e.g., 1) in an lth position of the selected binary sequence indicates that an lth candidate SRS transmission occasion is actually transmitted, and a second value (e.g., 0) in the lth location of the selected binary sequence indicates that the lth candidate SRS transmission occasion is not transmitted (that is, is muted), for l=1, 2, . . . , L. The set of binary sequences, from which the binary sequence is selected, may include K sequences, which can be indexed as k=0, 1, . . . K−1. A binary sequence with index k may be selected as a function of a time (e.g., a first slot and/or a first symbol number) associated with the bundle of L candidate SRS transmission occasions and based at least in part on a pseudo-random sequence. For example, a pseudo-random formula used to select the index k may be denoted as k(n_{s,f}^{μ}, l₀), denoting that k is a function of n_{s,f}^{μ} (a slot number of a first slot of a bundle of L candidate SRS transmission occasions) and l₀ (a symbol number of a first symbol of the bundle of L candidate SRS transmission occasions). In example 700, for a first bundle 705, a first binary sequence of 0100 is selected, such that only a second SRS transmission occasion 720 is selected for transmission of the SRS. For a second bundle 715, a second binary sequence of 0001 is selected, such that only a fourth SRS transmission occasion is selected for transmission of the SRS. The set of K binary sequences can include fewer than all possible binary sequences for a given L. As just one example, the set of K binary sequences can include [1000, 0100, 0010, 0001], ensuring that SRS transmissions of four UEs do not collide with one another.

There are situations where pseudo-random selection may lead to collision between SRS transmissions of UEs. For example, two UEs associated with the same TRP (e.g., intra-cell) or the same cluster (e.g., intra-cluster), and that do not have orthogonal configurations for transmitting the SRS (which may be implemented, for example, using a comb, a cyclic shift, a sequence, or the like), may select the same binary sequence if the two UEs use the same parameters to initialize the pseudo-random function (e.g., the same n_{s,f}^{μ}, l₀). However, interference randomization between cells (e.g., TRPs) and between clusters remains desirable as a way to reduce interference.

Some techniques described herein provide an offset for pseudo-random selection of SRS transmission occasions, such as for pseudo-random selection of the binary sequences described above. For example, a UE may receive information indicating the offset (e.g., from a network node) for a pseudo-random function used to select a set of SRS transmission occasions. The UE may transmit the one or more SRSs on the set of SRS transmission occasions based on both the offset and the pseudo-random function. Accordingly, unlike when only the pseudo-random function is used to select SRS transmission occasions, which may lead to collisions due to UEs selecting the same SRS transmission occasions when the same time based parameters are used in the pseudo-random function, using the offset in combination with the pseudo-random function reduces the likelihood of the same SRS transmission occasions being selected by UEs. Thus, interference among UEs (e.g., associated with a same cell or cluster) is reduced by using the offset.

In some examples, the offset may be fixed (that is, not random or pseudo-random), and may not change as a function of time. The offset may be used, in conjunction with the pseudo-random selection, to select a binary sequence. For example, the offset may cause each UE configured with a different offset and the same parameters (e.g., n_{s,f}^{μ} and l₀) for pseudo-random selection to select a different binary sequence. Different UEs associated with the same TRP (e.g., cell) and/or the same cluster may be configured with different offsets and the same set of parameters for pseudo-random selection, such that intra-cell or intra-cluster interference is reduced. UEs associated with different cells or different clusters may be configured with different sets of parameters for pseudo-random selection, which provides interference randomization for inter-cell or inter-cluster interference. Thus, interference among UEs associated with a given cell (e.g., intra-cell interference) or cluster (e.g., intra-cluster interference) is reduced by using the offset (which may be desirable since such interference may be stronger than inter-cell or inter-cluster interference), and inter-cell or inter-cluster interference may be reduced by initializing the pseudo-random function using different parameters.

As mentioned above, if two UEs select the same binary sequence for a set of SRS transmission occasions using the same parameters for the pseudo-random function, then a collision may occur between SRS transmissions of the two UEs. The likelihood of such a collision occurring may be proportionate to the number of binary sequences from which a binary sequence can be selected. For example, a smaller number of selectable binary sequences may be associated with a higher likelihood of collision. If such a collision occurs with a long set of SRS transmission occasions, then a large number of SRS transmissions may have unacceptable levels of (e.g., inter-cell or inter-cluster) interference across a time window, leading to degraded channel estimation and, thus, decreased throughput and reliability of CJT communications. This issue may be exacerbated for inter-cell interference and inter-cluster interference, since the two UEs may be associated with different controllers due to being associated with different cells or clusters, so a central controller may not be able to guarantee that there is no collision between SRS transmissions of the two UEs.

Some techniques described herein provide transmission of one or more SRSs on one or more SRS transmission occasions indicated by two or more binary sequences of a set of binary sequences. Each binary sequence, of the two or more binary sequences, may indicate one or more SRS transmission occasions, of two or more pluralities of SRS transmission occasions corresponding to the two or more binary sequences, for SRS transmission. The two or more binary sequences may be based at least in part on the initialization value and a time associated with an SRS transmission occasion of the two or more pluralities of SRS transmission occasions. Accordingly, unlike when only a single binary sequence is used to select SRS transmission occasions, which can lead to collision between two UEs across all SRS transmissions of the two UEs (referred to as a “full collision”), the likelihood of a full collision is reduced by the usage of the initialization value and the time for the two or more SRS transmission occasions. Thus, interference, particularly inter-cell interference and inter-cluster interference, is reduced.

In some aspects, the UE may select M binary sequences corresponding to M sets of SRS transmission occasions, where M is at least 2. Each set of SRS transmission occasions may include L SRS transmission occasions, such that the selected M binary sequences indicate whether or not M×L SRS transmission occasions are utilized for SRS transmission or not. The selection of the M binary sequences may be based at least in part on an initialization value selected from a group of up to K^{M} possible values (where K indicates the number of binary sequences in the set of selectable binary sequences). The initialization values may be configured such that, for a given time unit, different selections of M binary sequences (corresponding to different initialization values) are not identical to one another. For example, for a given time unit and M=2, even if two UEs associated with different initialization values select the same first binary sequence, the initialization values may be configured such that the two UEs are guaranteed to select a different second binary sequence, thereby reducing interference associated with collisions of SRSs. The M sets of SRS transmission occasions for which M binary sequences are selected may be referred to herein as an M-bundle. In this way, channel estimation using SRSs (such as for CJT) is improved, thereby increasing throughput and improving reliability of CJT communications.

As indicated above, FIG. 7 is provided as an example. Other examples may differ from what is described with regard to FIG. 7.

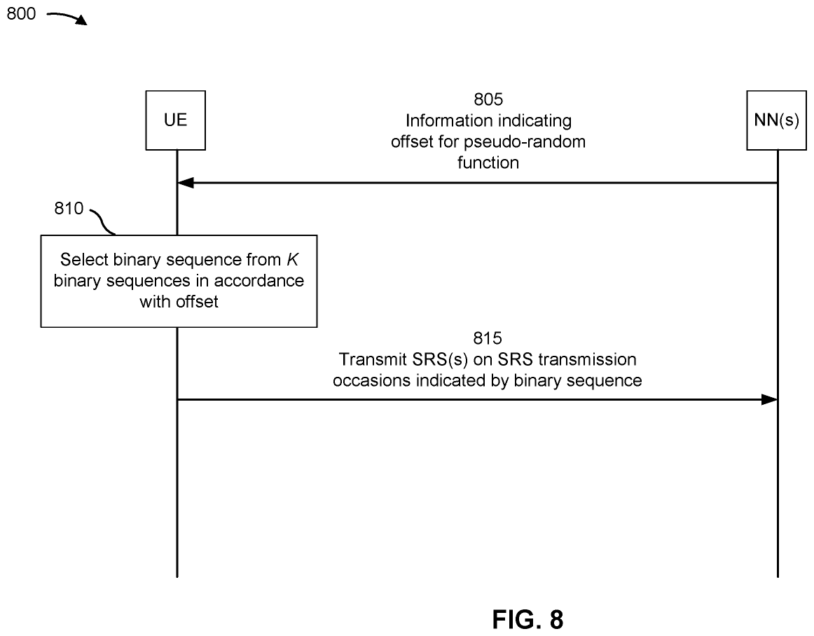

FIG. 8 is a diagram illustrating an example 800 of signaling associated with selecting SRS transmission occasions using an offset, in accordance with the present disclosure. As shown, example 800 includes a UE (e.g., UE 120) and a network node (e.g., network node 110). In some aspects, the network node may be associated with one or more TRPs, such as a plurality of TRPs configured for CJT to the UE.

As shown, the network node may output, and the UE may receive, information 805 indicating an offset for a pseudo-random function. For example, the network node may transmit the information 805 to the UE, or may provide the information 805 for transmission by another network node (e.g., network node 110). The offset may be referred to herein as k₀. In some aspects, the information 805 may be provided via RRC information. For example, the network node may output configuration information indicating the offset for the pseudo-random function. In some aspects, the information 805 may be specific to an SRS resource. For example, the network node may configure the offset per SRS resource (e.g., a parameter of a configuration of the SRS resource, or using configuration information that links the offset to an SRS resource). In some aspects, the information 805 may be specific to an SRS resource set. For example, the network node may configure the offset per SRS resource set. In some aspects, the information 805 may be specific to a component carrier (CC) or a bandwidth part (BWP). For example, the network node may configure the offset per CC or per BWP. In some aspects, the offset may be fixed. For example, the offset may not be random or pseudo-random. In some aspects, the offset may not change as a function of time. For example, the offset may not be related to or dependent on n_{s,f}^{μ} or l₀ defined above. In some aspects, the offset may be s, independent from an initialization of a pseudo-random sequence associated with a pseudo-random function, as described below.

In some aspects, the configuration information that provides the information 805 (or other signaling from the network node or another network node) may indicate configuration information associated with a set of SRS transmission occasions. For example, the configuration information may configure a set of SRS resources or SRS resource sets defining the set of SRS transmission occasions. As another example, the configuration information may configure a number of SRS transmission occasions in a set of SRS transmission occasions (e.g., referred to herein as L). As yet another example, the configuration information may configure a set of binary sequences (e.g., K binary sequences) from which the UE can select a binary sequence using a pseudo-random function. As another example, the configuration information may indicate one or more parameters of the pseudo-random function, such as an initialization value of the pseudo-random function, a pseudo-random sequence of the pseudo-random function, or the like.

As mentioned above, the UE may be configured with K binary sequences. The offset k₀ may be less than K (e.g., 0≤k₀<K). Thus, for a set of binary sequences including K binary sequences, the UE can be configured with a fixed offset k₀ (0≤k₀<K). Thus, the offset ensures that UEs, selecting from K binary sequences using the same parameters for a pseudo-random function (e.g., n_{s,f}^{μ}, l₀ a same pseudo-random sequence, or the like), select different binary sequences from the K binary sequences.

In some aspects, the network node may configure different UEs with different offsets. For example, the network node may configure a first UE with a first offset (selected from K−1 potential values of the offset) and a second UE with a second offset (selected from the K−1 potential values, and different from the first offset). In some aspects, the first UE and the second UE may be configured with a same set of binary sequences. Additionally, or alternatively, the first UE and the second UE may be associated with the same parameters of a pseudo-random function. In some aspects, the first UE and the second UE may be associated with a same TRP (e.g., a same cell), a same cluster, or the like. In some aspects, the network node may configure the same parameters of the pseudo-random function for UEs associated with a same TRP or a same cluster (e.g., for a plurality of L SRS transmission occasions with n_{s,f}^{μ} and l₀, k(n_{s,f}^{μ}, l₀) may be the same for all UEs associated with a same TRP or a same cluster), and may configure different offsets for the UEs (such that the UEs are configured not to pseudo-randomly select the same binary sequences). In some aspects, SRS transmissions of the first UE and the second UE may not be orthogonalized in a comb domain, a cyclic shift domain, or a sequence domain. In some aspects, the network node may configure an offset (e.g., the first offset, the second offset, the offset of the information 905) based at least in part on an interference threshold, such as a threshold level of interference associated with SRS transmission or channel estimation. In some aspects, the network node may configure different initializations for UEs associated with different TRPs or different clusters. For example, the network node may configure n_{s,f}^{μ}, l₀, a different pseudo-random sequence, or the like, for UEs associated with different TRPs or different clusters (e.g., for a plurality of L SRS transmission occasions with n_{s,f}^{μ} and l₀, k(n_{s,f}^{μ}, l₀) can be different across UEs in different clusters), which provides interference randomization for inter-cell or inter-cluster interference mitigation.

As shown by reference number 810, the UE may select a binary sequence from a set of K binary sequences in accordance with the offset. For example, the UE may select the binary sequence for a plurality of L SRS transmission occasions using the offset k₀ and the pseudo-random function k(n_{s,f}^{μ}, l₀). The pseudo-random function may be a function of a slot number of a first slot of the plurality of SRS transmission occasions (n_{s,f}^{μ}), a symbol number of a first symbol of the plurality of SRS transmission occasions (l₀), and a pseudo-random sequence. In some aspects, the UE may select a binary sequence identified by a binary sequence index. For example, the UE may determine the binary sequence index using a modulo operation (modulo K) of the sum of the offset and the pseudo-random function: binary sequence index=(k₀+k(n_{s,f}^{μ}, l₀)) mod K. Thus, the UE may select a set of SRS transmission occasions from the plurality of L SRS transmission occasions using the pseudo-random function and the offset (since the selected binary sequence indicates the set of SRS transmission occasions).

As mentioned above, in some aspects, different UEs associated with a given TRP or a given cluster may be configured with the same initialization for the pseudo-random function and different offsets. Thus, since k(n_{s,f}^{μ}, l₀) is the same for all UEs associated with the same TRP or the same cluster, (k 0+k(n_{s,f}^{μ}, l₀)) mod K is different across the UEs associated with the same TRP or the same cluster, since the configured offset (k₀) is different for each of the UEs. In this way, intra-cell or intra-TRP interference due to SRS transmission is reduced, which improves channel estimation and CJT.

As shown by reference number 815, the UE may transmit one or more SRSs on a set of (one or more) SRS transmission occasions based at least in part on the offset and the pseudo-random function. For example, the selected binary sequence (selected by the UE) may indicate the set of SRS transmission occasions. The UE may transmit one or more SRSs on the set of SRS transmission occasions.

As indicated above, FIG. 8 is provided as an example. Other examples may differ from what is described with regard to FIG. 8.

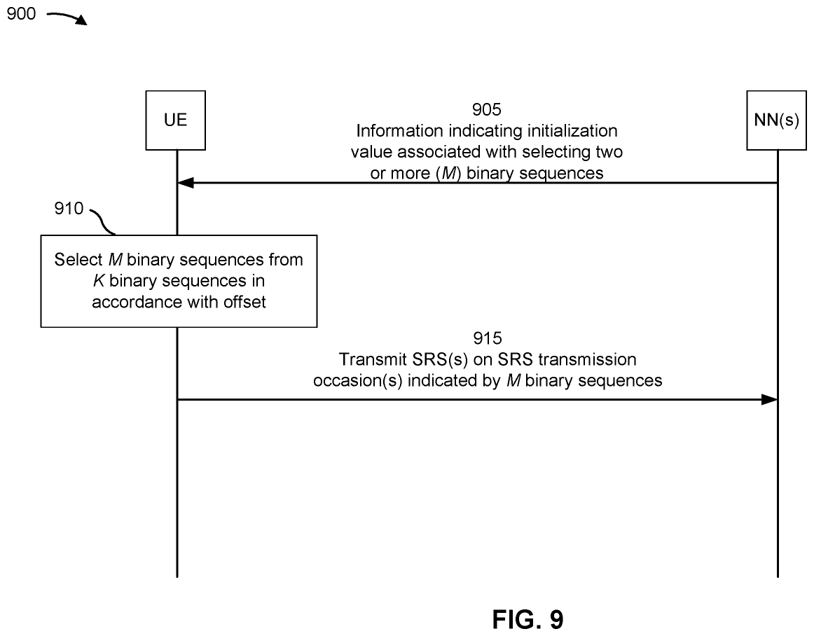

FIG. 9 is a diagram illustrating an example 900 of two or more binary sequences for SRS transmission occasions, in accordance with the present disclosure. As shown, example 900 includes a UE (e.g., UE 120) and a network node (e.g., network node 110). In some aspects, the network node may be associated with one or more TRPs, such as a plurality of TRPs configured for CJT to the UE.

As shown, the network node may output, and the UE may receive, information 905 indicating an initialization value associated with two or more binary sequences (e.g., M binary sequences) from a plurality of binary sequences (e.g., K binary sequences). For example, the network node may transmit the information 905 to the UE, or may provide the information 905 for transmission by another network node (e.g., network node 110). In some aspects, the information 905 may be provided via RRC information. For example, the network node may output configuration information indicating the initialization. In some aspects, the information 905 may be specific to an SRS resource. For example, the network node may configure the initialization value per SRS resource. In some aspects, the information 905 may be specific to an SRS resource set. For example, the network node may configure the initialization value per SRS resource set. In some aspects, the information 905 may be specific to a CC or a BWP. For example, the network node may configure the initialization value per CC or per BWP. The initialization value may be different from an initialization of the pseudo-random function described with regard to FIG. 8.

In some aspects, the configuration information that provides the information 805 (or other signaling from the network node or another network node) may indicate configuration information associated with two or more pluralities of SRS transmission occasions (e.g., two or more bundles of L SRS transmission occasions). For example, the configuration information may configure a set of SRS resources or SRS resource sets defining a plurality of SRS transmission occasions. As another example, the configuration information may configure a number of SRS transmission occasions in a plurality of SRS transmission occasions (e.g., where the number is referred to herein as L). As yet another example, the configuration information may configure a set of binary sequences (e.g., K binary sequences) from which the UE can identify M binary sequences using the initialization value. As another example, the configuration information may indicate one or more parameters of the pseudo-random function, such as an initialization of the pseudo-random function, a pseudo-random sequence of the pseudo-random function, or the like.

As mentioned above, the UE may be configured with K binary sequences. The UE may identify M binary sequences corresponding to M bundles of SRS transmission occasions (where the M bundles of SRS transmission occasions can be referred to as an M-bundle). Thus, the M-bundle may span L×M SRS transmission occasions. In some aspects, the information 905 may indicate a time, such as a first slot number associated with a first SRS transmission occasion of the M-bundle and/or a first symbol number associated with the first SRS transmission occasion (e.g., the first SRS transmission occasion of the L×M SRS transmission occasions).

The initialization value provided via the information 905 may be one of (e.g., up to) K^{M} possible initialization values. In some aspects, the initialization value may be considered a UE group identifier. The pseudo-random function, using the initialization value and a time associated with an SRS transmission occasion (e.g., the time associated with the first SRS transmission occasion described above), may ensure that, for a given time and for different initialization values (e.g., different UE group identifiers) the set of M binary sequences are not identical. For example, by providing up to K^{M} initialization values, non-identical selection of sets of M binary sequences can be ensured. For example, if M=2, and if up to K² initialization values are used, two UEs that select an identical first binary sequence can be configured not to select an identical second binary sequence. Thus, inter-cell and inter-cluster interference is reduced, which improves channel estimation and CJT transmission.

As shown by reference number 910, the UE may select M binary sequences. For example, the UE 120 may select the M binary sequences based at least in part on a pseudo-random function that is a function of at least the initialization value received in the information 905 and a time (e.g., the time associated with the first SRS transmission occasion, described above).

As shown by reference number 915, the UE may transmit one or more SRSs on one or more SRS transmission occasions. For example, the M binary sequences may indicate one or more SRS transmission occasions. In some aspects, each binary sequence of the M binary sequences may indicate one or more SRS transmission occasions (where different binary sequences can indicate different SRS transmission occasions). For example, a first binary sequence may indicate a first one or more SRS transmission occasions and a second binary sequence may indicate a second one or more SRS transmission occasions. The one or more SRS transmission occasions may belong to at least one of M bundles (e.g., two or more pluralities of SRS transmission occasions) corresponding to the M binary sequences. For example, each bit, of the M binary sequences, may indicate whether a corresponding SRS transmission occasion, of the two or more pluralities of SRS transmission occasions, is used for transmission of the one or more SRSs.

As indicated above, FIG. 9 is provided as an example. Other examples may differ from what is described with regard to FIG. 9.

In some aspects, the operations of example 800 and example 900 can be combined. For example, a UE can be configured with an offset (e.g., in the information 805) and an initialization value (in the information 905). The UE may use the offset and the initialization value to select M binary sequences, and may transmit one or more SRSs on one or more SRS transmission occasions indicated by the M binary sequences. Thus, intra-cell or intra-cluster interference is mitigated, as well as inter-cell or inter-cluster interference.

FIG. 10 is a diagram illustrating an example process 1000 performed, for example, by a UE, in accordance with the present disclosure. Example process 1000 is an example where the UE (e.g., UE 120) performs operations associated with techniques for pseudo-random muting for a sounding reference signal.

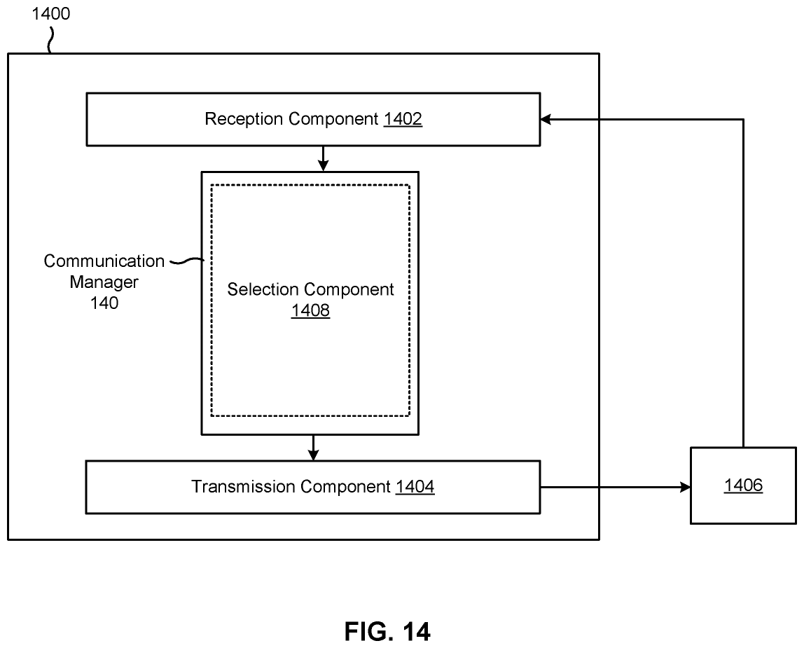

As shown in FIG. 10, in some aspects, process 1000 may include receiving information indicating an offset for a pseudo-random function used to select a set of SRS transmission occasions from a plurality of SRS transmission occasions (block 1010). For example, the UE (e.g., using communication manager 140 and/or reception component 1402, depicted in FIG. 14) may receive information indicating an offset for a pseudo-random function used to select a set of SRS transmission occasions from a plurality of SRS transmission occasions, as described above.

As further shown in FIG. 10, in some aspects, process 1000 may include transmitting one or more SRSs on the set of SRS transmission occasions based at least in part on the offset and the pseudo-random function (block 1020). For example, the UE (e.g., using communication manager 140 and/or transmission component 1404, depicted in FIG. 14) may transmit one or more SRSs on the set of SRS transmission occasions based at least in part on the offset and the pseudo-random function, as described above.

Process 1000 may include additional aspects, such as any single aspect or any combination of aspects described below and/or in connection with one or more other processes described elsewhere herein.

In a first aspect, the offset is a fixed offset.

In a second aspect, alone or in combination with the first aspect, the offset is independent of an initialization of a pseudo-random sequence of the pseudo-random function.

In a third aspect, alone or in combination with one or more of the first and second aspects, receiving the information indicating the offset further comprises receiving RRC information indicating the offset.

In a fourth aspect, alone or in combination with one or more of the first through third aspects, the information indicating the offset is specific to at least one of an SRS resource, an SRS resource set, a component carrier, or a bandwidth part.

In a fifth aspect, alone or in combination with one or more of the first through fourth aspects, process 1000 includes selecting the set of SRS transmission occasions using the pseudo-random function and the offset.

In a sixth aspect, alone or in combination with one or more of the first through fifth aspects, the pseudo-random function is a function of a slot number of a first slot of the plurality of SRS transmission occasions, a symbol number of a first symbol of the plurality of SRS transmission occasions, and a pseudo-random sequence.

In a seventh aspect, alone or in combination with one or more of the first through sixth aspects, the pseudo-random function is based at least in part on a number of binary sequences in a set of binary sequences, wherein the offset is less than the number of binary sequences.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with techniques for pseudo-random muting for a sounding reference signal.

As shown in FIG. 11, in some aspects, process 1100 may include receiving an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission (block 1110). For example, the UE (e.g., using communication manager 140 and/or reception component 1402, depicted in FIG. 14) may receive an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission, as described above.

As further shown in FIG. 11, in some aspects, process 1100 may include transmitting one or more SRSs on the one or more SRS transmission occasions based at least in part on the initialization value and a time associated with an SRS transmission occasion of the two or more pluralities of SRS transmission occasions (block 1120). For example, the UE (e.g., using communication manager 140 and/or transmission component 1404, depicted in FIG. 14) may transmit one or more SRSs on the one or more SRS transmission occasions based at least in part on the initialization value and a time associated with an SRS transmission occasion of the two or more pluralities of SRS transmission occasions, as described above.

Process 1100 may include additional aspects, such as any single aspect or any combination of aspects described below and/or in connection with one or more other processes described elsewhere herein.

In a first aspect, process 1100 includes receiving configuration information indicating a number of SRS transmission occasions in each plurality of SRS transmission occasions of the two or more pluralities of SRS transmission occasions and a number of binary sequences of the two or more binary sequences.

In a second aspect, alone or in combination with the first aspect, receiving the initialization value further comprises receiving RRC information indicating the initialization value.

In a third aspect, alone or in combination with one or more of the first and second aspects, the initialization value is specific to at least one of an SRS resource, an SRS resource set, a component carrier, or a bandwidth part.

In a fourth aspect, alone or in combination with one or more of the first through third aspects, the set of binary sequences comprises K binary sequences, the two or more binary sequences comprise M binary sequences, and the initialization value is one of (e.g., selected from) K^{M} initialization values.

In a fifth aspect, alone or in combination with one or more of the first through fourth aspects, each bit, of the two or more binary sequences, indicates whether a corresponding SRS transmission occasion, of the two or more pluralities of SRS transmission occasions, is used for transmission of the one or more SRSs.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with techniques for pseudo-random muting for a sounding reference signal.

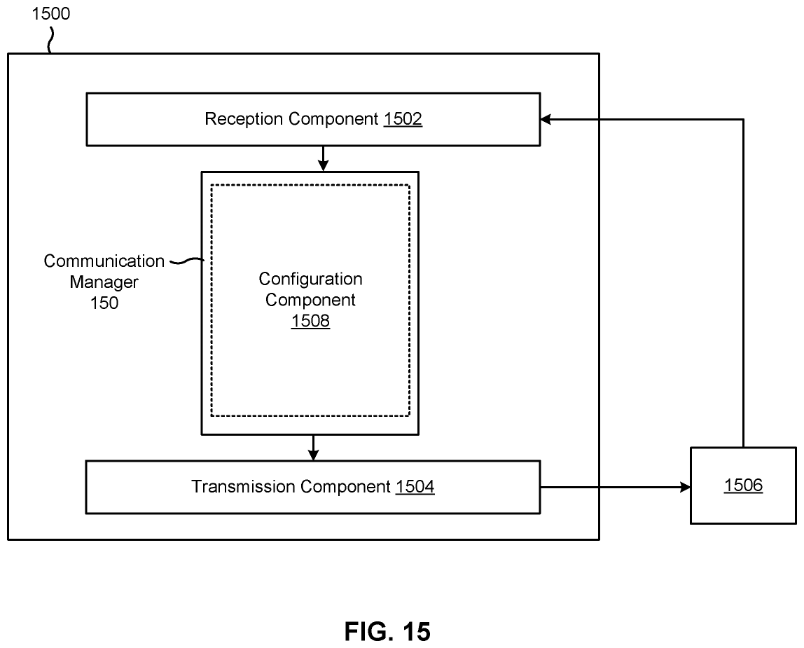

As shown in FIG. 12, in some aspects, process 1200 may include outputting information indicating an offset for a pseudo-random function used to select a set of SRS transmission occasions from a plurality of SRS transmission occasions (block 1210). For example, the network node (e.g., using communication manager 150 and/or transmission component 1504, depicted in FIG. 15) may output information indicating an offset for a pseudo-random function used to select a set of SRS transmission occasions from a plurality of SRS transmission occasions, as described above.

As further shown in FIG. 12, in some aspects, process 1200 may include obtaining one or more SRSs on the set of SRS transmission occasions based at least in part on the offset and the pseudo-random function (block 1220). For example, the network node (e.g., using communication manager 150 and/or reception component 1502, depicted in FIG. 15) may obtain one or more SRSs on the set of SRS transmission occasions based at least in part on the offset and the pseudo-random function, as described above.

Process 1200 may include additional aspects, such as any single aspect or any combination of aspects described below and/or in connection with one or more other processes described elsewhere herein.

In a first aspect, the offset is a fixed offset.

In a second aspect, alone or in combination with the first aspect, the offset is independent of an initialization of a pseudo-random sequence of the pseudo-random function.

In a third aspect, alone or in combination with one or more of the first and second aspects, outputting the information indicating the offset further comprises outputting RRC information indicating the offset.

In a fourth aspect, alone or in combination with one or more of the first through third aspects, the information indicating the offset is specific to at least one of an SRS resource, an SRS resource set, a component carrier, or a bandwidth part.

In a fifth aspect, alone or in combination with one or more of the first through fourth aspects, the pseudo-random function is based at least in part on a number of binary sequences in a set of binary sequences, wherein the offset is less than the number of binary sequences.

In a sixth aspect, alone or in combination with one or more of the first through fifth aspects, outputting the information indicating the offset further comprises outputting the information indicating the offset for a first UE, the offset is a first offset, and process 1200 includes outputting information indicating a second offset, different than the first offset, for a second UE.

In a seventh aspect, alone or in combination with one or more of the first through sixth aspects, the first offset and the second offset are different from one another based at least in part on the first UE and the second UE being associated with a same TRP or a same cluster.

In an eighth aspect, alone or in combination with one or more of the first through seventh aspects, the first UE and the second UE are associated with a first TRP or a first cluster, and process 1200 includes outputting information indicating the first offset for a third UE, wherein the first UE is associated with a first parameter for the pseudo-random function and the second UE is associated with a second parameter, for the pseudo-random function, different than the first parameter.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with techniques for pseudo-random muting for a sounding reference signal.

As shown in FIG. 13, in some aspects, process 1300 may include outputting an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission (block 1310). For example, the network node (e.g., using communication manager 150 and/or transmission component 1504, depicted in FIG. 15) may output an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission, as described above.

As further shown in FIG. 13, in some aspects, process 1300 may include obtaining one or more SRSs on the one or more SRS transmission occasions based at least in part on the initialization value and a time associated with an SRS transmission occasion of the two or more pluralities of SRS transmission occasions (block 1320). For example, the network node (e.g., using communication manager 150 and/or reception component 1502, depicted in FIG. 15) may obtain one or more SRSs on the one or more SRS transmission occasions based at least in part on the initialization value and a time associated with an SRS transmission occasion of the two or more pluralities of SRS transmission occasions, as described above.

Process 1300 may include additional aspects, such as any single aspect or any combination of aspects described below and/or in connection with one or more other processes described elsewhere herein.

In a first aspect, process 1300 includes outputting configuration information indicating a number of SRS transmission occasions in each plurality of SRS transmission occasions of the two or more pluralities of SRS transmission occasions and a number of binary sequences to select from the set of binary sequences.

In a second aspect, alone or in combination with the first aspect, outputting the initialization value further comprises outputting RRC information indicating the initialization value.

In a third aspect, alone or in combination with one or more of the first and second aspects, the initialization value is specific to at least one of an SRS resource, an SRS resource set, a component carrier, or a bandwidth part.

In a fourth aspect, alone or in combination with one or more of the first through third aspects, the set of binary sequences comprises K binary sequences, the two or more binary sequences comprise M binary sequences, and the initialization value is one of (e.g., selected from) initialization values.

In a fifth aspect, alone or in combination with one or more of the first through fourth aspects, each bit, of the two or more binary sequences, indicates whether a corresponding SRS transmission occasion, of the two or more pluralities of SRS transmission occasions, is used for transmission of the one or more SRSs.

In a sixth aspect, alone or in combination with one or more of the first through fifth aspects, outputting the initialization value further comprises outputting the initialization value for a first UE associated with a first transmission reception point (TRP) or a first cluster, wherein the initialization value is a first initialization value, and process 1300 includes outputting a second initialization value, different than the first initialization value, for a second UE associated with a second TRP or a second cluster.

In a seventh aspect, alone or in combination with one or more of the first through sixth aspects, the two or more binary sequences are based at least in part on a pseudo-random function, and the pseudo-random function is configured such that the two or more binary sequences associated with the first initialization value are not identical to two or more binary sequences associated with the second initialization value.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include a selection component 1408, among other examples.

In some aspects, the apparatus 1400 may be configured to perform one or more operations described herein in connection with FIGS. 4-9. Additionally, or alternatively, the apparatus 1400 may be configured to perform one or more processes described herein, such as process 1000 of FIG. 10, process 1100 of FIG. 11, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The reception component 1402 may receive information indicating an offset for a pseudo-random function used to select a set of SRS transmission occasions from a plurality of SRS transmission occasions. The transmission component 1404 may transmit one or more SRSs on the set of SRS transmission occasions based at least in part on the offset and the pseudo-random function.

The selection component 1408 may select the set of SRS transmission occasions using the pseudo-random function and the offset.

The reception component 1402 may receive an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission. The transmission component 1404 may transmit one or more SRSs on the one or more SRS transmission occasions based at least in part on the initialization value and a time associated with an SRS transmission occasion of the two or more pluralities of SRS transmission occasions.

The reception component 1402 may receive configuration information indicating a number of SRS transmission occasions in each plurality of SRS transmission occasions of the two or more pluralities of SRS transmission occasions and a number of binary sequences to select from the set of binary sequences.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include a configuration component 1508, among other examples.

In some aspects, the apparatus 1500 may be configured to perform one or more operations described herein in connection with FIGS. 4-9. Additionally, or alternatively, the apparatus 1500 may be configured to perform one or more processes described herein, such as process 1200 of FIG. 12, process 1300 of FIG. 13, or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The transmission component 1504 or the configuration component 1508 may output information indicating an offset for a pseudo-random function used to select a set of SRS transmission occasions from a plurality of SRS transmission occasions. The reception component 1502 may obtain one or more SRSs on the set of SRS transmission occasions based at least in part on the offset and the pseudo-random function.

The transmission component 1504 or the configuration component 1508 may output an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission. The reception component 1502 may obtain one or more SRSs on the one or more SRS transmission occasions based at least in part on the initialization value and a time associated with an SRS transmission occasion of the two or more pluralities of SRS transmission occasions.

The configuration component 1508 may output configuration information indicating a number of SRS transmission occasions in each plurality of SRS transmission occasions of the two or more pluralities of SRS transmission occasions and a number of binary sequences to select from the set of binary sequences.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving information indicating an offset for a pseudo-random function used to select a set of sounding reference signal (SRS) transmission occasions from a plurality of SRS transmission occasions; and transmitting one or more SRSs on the set of SRS transmission occasions based at least in part on the offset and the pseudo-random function.

Aspect 2: The method of Aspect 1, wherein the offset is a fixed offset.

Aspect 3: The method of any of Aspects 1-2, wherein the offset is independent of an initialization of a pseudo-random sequence of the pseudo-random function.

Aspect 4: The method of any of Aspects 1-3, wherein receiving the information indicating the offset further comprises receiving radio resource control (RRC) information indicating the offset.

Aspect 5: The method of any of Aspects 1-4, wherein the information indicating the offset is specific to at least one of: an SRS resource, an SRS resource set, a component carrier, or a bandwidth part.

Aspect 6: The method of any of Aspects 1-5, further comprising selecting the set of SRS transmission occasions using the pseudo-random function and the offset.

Aspect 7: The method of Aspect 6, wherein the pseudo-random function is a function of a slot number of a first slot of the plurality of SRS transmission occasions, a symbol number of a first symbol of the plurality of SRS transmission occasions, and a pseudo-random sequence.

Aspect 8: The method of any of Aspects 1-7, wherein the pseudo-random function is based at least in part on a number of binary sequences in a set of binary sequences, wherein the offset is less than the number of binary sequences.

Aspect 9: A method of wireless communication performed by a user equipment (UE), comprising: receiving an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission; and transmitting one or more SRSs on the one or more SRS transmission occasions based at least in part on the initialization value and a time associated with an SRS transmission occasion of the two or more pluralities of SRS transmission occasions.

Aspect 10: The method of Aspect 9, further comprising receiving configuration information indicating a number of SRS transmission occasions in each plurality of SRS transmission occasions of the two or more pluralities of SRS transmission occasions and a number of binary sequences of the two or more binary sequences.

Aspect 11: The method of any of Aspects 9-10, wherein receiving the initialization value further comprises receiving radio resource control (RRC) information indicating the initialization value.

Aspect 12: The method of any of Aspects 9-11, wherein the initialization value is specific to at least one of: an SRS resource, an SRS resource set, a component carrier, or a bandwidth part.

Aspect 13: The method of any of Aspects 9-12, wherein the set of binary sequences comprises K binary sequences, the two or more binary sequences comprise M binary sequences, and the initialization value is one of K^{M} initialization values.

Aspect 14: The method of any of Aspects 9-13, wherein each bit, of the two or more binary sequences, indicates whether a corresponding SRS transmission occasion, of the two or more pluralities of SRS transmission occasions, is used for transmission of the one or more SRSs.

Aspect 15: A method of wireless communication performed by a network node, comprising: outputting information indicating an offset for a pseudo-random function used to select a set of sounding reference signal (SRS) transmission occasions from a plurality of SRS transmission occasions; and obtaining one or more SRSs on the set of SRS transmission occasions based at least in part on the offset and the pseudo-random function.

Aspect 16: The method of Aspect 15, wherein the offset is a fixed offset.

Aspect 17: The method of any of Aspects 15-16, wherein the offset is independent of an initialization of a pseudo-random sequence of the pseudo-random function.

Aspect 18: The method of any of Aspects 15-17, wherein outputting the information indicating the offset further comprises outputting radio resource control (RRC) information indicating the offset.

Aspect 19: The method of any of Aspects 15-18, wherein the information indicating the offset is specific to at least one of: an SRS resource, an SRS resource set, a component carrier, or a bandwidth part.

Aspect 20: The method of any of Aspects 15-19, wherein the pseudo-random function is based at least in part on a number of binary sequences in a set of binary sequences, wherein the offset is less than the number of binary sequences.

Aspect 21: The method of any of Aspects 15-20, wherein outputting the information indicating the offset further comprises outputting the information indicating the offset for a first UE, the offset is a first offset, and the method further comprises: outputting information indicating a second offset, different than the first offset, for a second UE.

Aspect 22: The method of Aspect 21, wherein the first offset and the second offset are different from one another based at least in part on the first UE and the second UE being associated with a same transmission reception point (TRP) or a same cluster.

Aspect 23: The method of Aspect 22, wherein the first UE and the second UE are associated with a first TRP or a first cluster, and wherein the method further comprises: outputting information indicating the first offset for a third UE, wherein the first UE is associated with a first parameter for the pseudo-random function and the second UE is associated with a second parameter, for the pseudo-random function, different than the first parameter.

Aspect 24: A method of wireless communication performed by a network node, comprising: outputting an initialization value associated with two or more binary sequences from a set of binary sequences, each binary sequence, of the two or more binary sequences, indicating one or more SRS transmission occasions, of two or more pluralities of SRS transmission occasions corresponding to the two or more binary sequences, for SRS transmission; and obtaining one or more SRSs on the one or more SRS transmission occasions based at least in part on the initialization value and a time associated with an SRS transmission occasion of the two or more pluralities of SRS transmission occasions.

Aspect 25: The method of Aspect 24, further comprising outputting configuration information indicating a number of SRS transmission occasions in each plurality of SRS transmission occasions of the two or more pluralities of SRS transmission occasions and a number of binary sequences of the two or more binary sequences.

Aspect 26: The method of any of Aspects 24-25, wherein outputting the initialization value further comprises outputting radio resource control (RRC) information indicating the initialization value.

Aspect 27: The method of any of Aspects 24-26, wherein the initialization value is specific to at least one of: an SRS resource, an SRS resource set, a component carrier, or a bandwidth part.

Aspect 28: The method of any of Aspects 24-27, wherein the set of binary sequences comprises K binary sequences, the two or more binary sequences comprise M binary sequences, and the initialization value is one of K^{M} initialization values.

Aspect 29: The method of any of Aspects 24-28, wherein each bit, of the two or more binary sequences, indicates whether a corresponding SRS transmission occasion, of the two or more pluralities of SRS transmission occasions, is used for transmission of the one or more SRSs.

Aspect 30: The method of any of Aspects 24-29, wherein outputting the initialization value further comprises outputting the initialization value for a first UE associated with a first transmission reception point (TRP) or a first cluster, wherein the initialization value is a first initialization value, and wherein the method further comprises: outputting a second initialization value, different than the first initialization value, for a second UE associated with a second TRP or a second cluster.

Aspect 31: The method of Aspect 30, wherein the two or more binary sequences are based at least in part on a pseudo-random function, and wherein the pseudo-random function is configured such that the two or more binary sequences associated with the first initialization value are not identical to two or more binary sequences associated with the second initialization value.

Aspect 32: An apparatus for wireless communication at a device, comprising a processor; memory coupled with the processor; and instructions stored in the memory and executable by the processor to cause the apparatus to perform the method of one or more of Aspects 1-31.

Aspect 33: A device for wireless communication, comprising a memory and one or more processors coupled to the memory, the one or more processors configured to perform the method of one or more of Aspects 1-31.

Aspect 34: An apparatus for wireless communication, comprising at least one means for performing the method of one or more of Aspects 1-31.

Aspect 35: A non-transitory computer-readable medium storing code for wireless communication, the code comprising instructions executable by a processor to perform the method of one or more of Aspects 1-31.

Aspect 36: A non-transitory computer-readable medium storing a set of instructions for wireless communication, the set of instructions comprising one or more instructions that, when executed by one or more processors of a device, cause the device to perform the method of one or more of Aspects 1-31.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A user equipment (UE) for wireless communication, comprising:
a memory; and
one or more processors, coupled to the memory, configured to:
receive information indicating an offset for a pseudo-random function used to select a set of sounding reference signal (SRS) transmission occasions from a plurality of SRS transmission occasions; and
transmit one or more SRSs on the set of SRS transmission occasions based at least in part on the offset and the pseudo-random function.

2. The UE of claim 1, wherein the offset is a fixed offset.

3. The UE of claim 1, wherein the offset is independent of an initialization of a pseudo-random sequence of the pseudo-random function.

4. The UE of claim 1, wherein the one or more processors, to receive the information indicating the offset, are configured to receive radio resource control (RRC) information indicating the offset.

5. The UE of claim 1, wherein the information indicating the offset is specific to at least one of:
an SRS resource,
an SRS resource set,
a component carrier, or
a bandwidth part.

6. The UE of claim 1, wherein the one or more processors are further configured to select the set of SRS transmission occasions using the pseudo-random function and the offset.

7. The UE of claim 6, wherein the pseudo-random function is a function of a slot number of a first slot of the plurality of SRS transmission occasions, a symbol number of a first symbol of the plurality of SRS transmission occasions, and a pseudo-random sequence.

8. The UE of claim 1, wherein the pseudo-random function is based at least in part on a number of binary sequences in a set of binary sequences, wherein the offset is less than the number of binary sequences.

9. A user equipment (UE) for wireless communication, comprising:
a memory; and
one or more processors, coupled to the memory, configured to:
receive an initialization value associated with two or more binary sequences from a set of binary sequences, each binary sequence of the two or more binary sequences indicating one or more SRS transmission occasions, of two or more pluralities of SRS transmission occasions corresponding to the two or more binary sequences, for SRS transmission; and
transmit one or more SRSs on the one or more SRS transmission occasions based at least in part on the initialization value and a time associated with an SRS transmission occasion of the two or more pluralities of SRS transmission occasions.

10. The UE of claim 9, wherein the one or more processors are further configured to receive configuration information indicating a number of SRS transmission occasions in each plurality of SRS transmission occasions of the two or more pluralities of SRS transmission occasions and a number of binary sequences of the two or more binary sequences.

11. The UE of claim 9, wherein the one or more processors, to receive the initialization value, are configured to receive radio resource control (RRC) information indicating the initialization value.

12. The UE of claim 9, wherein the initialization value is specific to at least one of:
an SRS resource,
an SRS resource set,
a component carrier, or
a bandwidth part.

13. The UE of claim 9, wherein the set of binary sequences comprises K binary sequences, the two or more binary sequences comprise M binary sequences, and the initialization value is one of K^{M} initialization values.

14. The UE of claim 9, wherein each bit, of the two or more binary sequences, indicates whether a corresponding SRS transmission occasion, of the two or more pluralities of SRS transmission occasions, is used for transmission of the one or more SRSs.

15. A network node for wireless communication, comprising:
a memory; and
one or more processors, coupled to the memory, configured to:
output information indicating an offset for a pseudo-random function used to select a set of sounding reference signal (SRS) transmission occasions from a plurality of SRS transmission occasions; and
obtain one or more SRSs on the set of SRS transmission occasions based at least in part on the offset and the pseudo-random function.

16. The network node of claim 15, wherein the offset is a fixed offset.

17. The network node of claim 15, wherein the offset is independent of an initialization of a pseudo-random sequence of the pseudo-random function.

18. The network node of claim 15, wherein the one or more processors, to output the information indicating the offset, are configured to output radio resource control (RRC) information indicating the offset.

19. The network node of claim 15, wherein the information indicating the offset is specific to at least one of:
an SRS resource,
an SRS resource set,
a component carrier, or
a bandwidth part.

20. The network node of claim 15, wherein the pseudo-random function is based at least in part on a number of binary sequences in a set of binary sequences, wherein the offset is less than the number of binary sequences.

21. The network node of claim 15, wherein the one or more processors, to output the information indicating the offset, are configured to output the information indicating the offset for a first UE, the offset is a first offset, and the one or more processors are further configured to output information indicating a second offset, different than the first offset, for a second UE.

22. The network node of claim 21, wherein the first offset and the second offset are different from one another based at least in part on the first UE and the second UE being associated with a same transmission reception point (TRP) or a same cluster.

23. The network node of claim 22, wherein the first UE and the second UE are associated with a first TRP or a first cluster, and wherein the one or more processors are further configured to output information indicating the first offset for a third UE, wherein the first UE is associated with a first parameter for the pseudo-random function and the second UE is associated with a second parameter, for the pseudo-random function, different than the first parameter.

24. A network node for wireless communication, comprising:
a memory; and
one or more processors, coupled to the memory, configured to:
output an initialization value associated with two or more binary sequences from a set of binary sequences, each binary sequence, of the two or more binary sequences, indicating one or more sounding reference signal (SRS) transmission occasions, of two or more pluralities of SRS transmission occasions corresponding to the two or more binary sequences, for SRS transmission; and
obtain one or more SRSs on the one or more SRS transmission occasions based at least in part on the initialization value and a time associated with an SRS transmission occasion of the two or more pluralities of SRS transmission occasions.

25. The network node of claim 24, wherein the one or more processors are further configured to output configuration information indicating a number of SRS transmission occasions in each plurality of SRS transmission occasions of the two or more pluralities of SRS transmission occasions and a number of binary sequences of the two or more binary sequences.

26. The network node of claim 24, wherein the one or more processors, to output the initialization value, are configured to output radio resource control (RRC) information indicating the initialization value.

27. The network node of claim 24, wherein the initialization value is specific to at least one of:
an SRS resource,
an SRS resource set,
a component carrier, or
a bandwidth part.

28. The network node of claim 24, wherein the set of binary sequences comprises K binary sequences, the two or more binary sequences comprise M binary sequences, and the initialization value is one of K M initialization values.

29. The network node of claim 24, wherein each bit, of the two or more binary sequences, indicates whether a corresponding SRS transmission occasion, of the two or more pluralities of SRS transmission occasions, is used for transmission of the one or more SRSs.

30. The network node of claim 24, wherein the one or more processors, to output the initialization value, are further configured to output the initialization value for a first UE associated with a first transmission reception point (TRP) or a first cluster, wherein the initialization value is a first initialization value, and wherein the one or more processors are further configured to output a second initialization value, different than the first initialization value, for a second UE associated with a second TRP or a second cluster.
